(19) United States
(12) Patent Application Publication
(10) Pub. No.: US 2024/0012052 A1
(43) Pub. Date: Jan. 11, 2024

(54) MACRO MODEL OF A SEMICONDUCTOR INTEGRATED CIRCUIT DEVICE, A CIRCUIT DESIGN SIMULATION PROGRAM, AND A CIRCUIT DESIGN SIMULATOR

(71) Applicant: ROHM CO., LTD., Kyoto (JP)

(72) Inventors: Kyoji MARUMOTO, Kyoto (JP); Takuya KATAYAMA, Kyoto (JP)

(21) Appl. No.: 18/474,372

(22) Filed: Sep. 26, 2023

Related U.S. Application Data
(63) Continuation of application No. PCT/JP2022/006357, filed on Feb. 17, 2022.

(30) Foreign Application Priority Data
Mar. 29, 2021 (JP) 2021-054932

(51) Int. Cl. G01R 31/3183; G01R 31/317; H03K 19/17728

(52) U.S. Cl. CPC G01R 31/318357; G01R 31/31721; H03K 19/17728

(57) ABSTRACT

For example, a macro model of a semiconductor integrated circuit device is used in a circuit design simulator, and comprises a plurality of functional blocks and a characteristic setting block. The functional blocks are each configured to cause the circuit design simulator to show approximate representation or equivalent representation of the characteristic of the semiconductor integrated circuit device. The characteristic setting block sets at least one of a plurality of internal parameters provided in the functional blocks by using array data derived from evaluation measurement data obtained by actual measurement of the semiconductor integrated circuit device.

### CROSS-REFERENCE TO RELATED APPLICATIONS

This nonprovisional application is a continuation application of International Patent Application No. PCT/JP2022/006357 filed on Feb. 17, 2022, which claims priority Japanese Patent Application No. 2021-054932 filed on Mar. 29, 2021, the entire contents of which are hereby incorporated by reference.

### TECHNICAL FIELD

The present disclosure relates to a macro model of a semiconductor integrated circuit device, and to a circuit design simulation program and a circuit design simulator that employ such a macro model.

### BACKGROUND ART

Conventionally, as a tool for assisting the designing of a semiconductor integrated circuit device, a wide use is made of design simulation programs (for example, SPICE [simulation program with integrated circuit emphasis] circuit design simulation programs). A circuit design simulation program is a software program that makes a computer executing it function as a circuit design simulator. On a circuit design simulator, it is possible to create an analog circuit by combining various simulation models (passive element models such as a resistor and a capacitor, active element models such as a transistor and a diode, and macro models such as an operational amplifier) with a voltage source, a current source, a wiring, and the like to simulate the response of the circuit.

An example of known technology related to what has just been mentioned is seen in Patent Document 1 identified below.

### LIST OF CITATIONS

### Patent Literature

Patent Document 1: Japanese unexamined patent application publication No. 2012-216187

### BRIEF DESCRIPTION OF DRAWINGS

FIG. 1 is a diagram showing an actual circuit example of an operational amplifier.

FIG. 2 is a diagram showing a comparative example of a macro model.

FIG. 3 is a diagram showing characteristics of the operational amplifier.

FIG. 4 is a diagram showing a macro model according to a first embodiment.

FIG. 5 is a diagram showing a macro model according to a second embodiment.

FIG. 6 is a diagram showing interpolation operation for an internal parameter.

FIG. 7 is a diagram showing one configuration example of a circuit design simulator.

FIG. 8 is a diagram showing one configuration example of a circuit design simulation program.

### DESCRIPTION OF EMBODIMENTS

<Operational Amplifier>

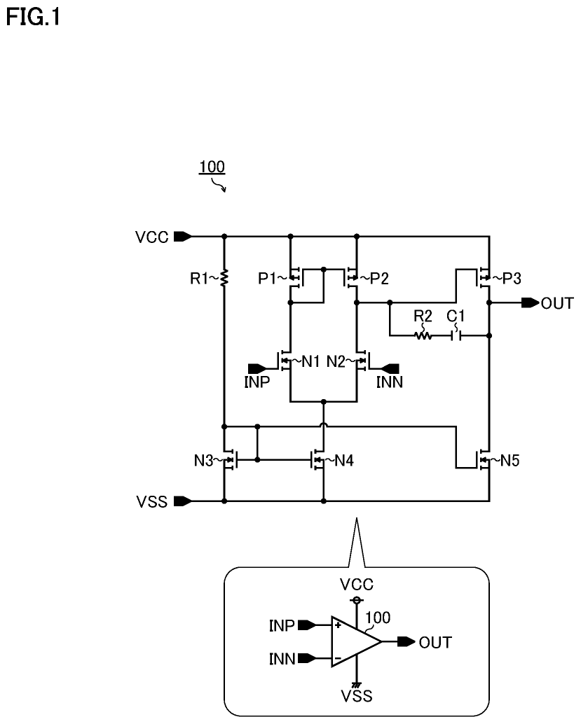

FIG. 1 is a diagram showing an actual circuit example of an operational amplifier. The operational amplifier 100 of this configuration example includes N-channel MOS [metal-oxide-semiconductor] field-effect transistors N1 to N5, P-channel MOS field-effect transistors P1 to P3, resistors R1 to R2, and a capacitor C1.

One terminal of the resistor R1 and the sources of the transistors P1, P2, and P3 are all connected to the supply voltage node (that is, an application terminal for a supply voltage VCC) of the operational amplifier 100. The second terminal of the resistor R1 is connected to the drain of the transistor N3. The gates of the transistors P1 and P2 are both connected to the drain of the transistor P1. The drain of the transistor P2, the gate of the transistor P3, and the first terminal of the resistor R2 are all connected to the drain of the transistor N2. The second terminal of the resistor R2 is connected to the first terminal of the capacitor C1. The drains of the transistors P3 and N5 and the second terminal of the capacitor C1 are all connected to the output node (that is, an output terminal for an output signal OUT) of the operational amplifier 100.

The gate of the transistor N1 is connected to the non-inverting input node (that is, an input terminal for a first input signal INP) of the operational amplifier 100. The gate of the transistor N2 is connected to the non-inverting input node (that is, an input terminal for a second input signal INN) of the operational amplifier 100. The sources of the transistors N1 and N2 are both connected to the drain of the transistor N4. The gates of the transistors N3, N4, and N5 are all connected to the drain of the transistor N3. The sources of the transistors N3, N4, and N5 are all connected to the reference voltage node (that is, an application terminal for a reference voltage VSS) of the operational amplifier 100.

The operational amplifier 100 of this configuration example amplifies the difference between the first and second input signals INP and INN at a gain a to generate an output signal OUT (=a×(INP−INN)).

Incidentally, with respect to semiconductor integrated circuit devices (LSI products in general), to provide a highly accurate simulation model that covers all actual operation conditions, it is necessary to represent all the circuit elements (transistors, resistors, capacitors, etc.) constituting a semiconductor integrated circuit device with element models and make a model of (hereinafter, model) an actual analog circuit itself.

However, by such a method, even simulating a small-scale semiconductor integrated circuit device takes a long time for computation by a circuit design simulator (such as a computer). In particular, simulating a large-scale system such as a PCB [printed circuit board] incorporating a semiconductor integrated circuit device takes too much time and may lead to slow progress of system designing.

In this way, it is not realistic to model an actual analog circuit itself to enhance the accuracy of simulation of a semiconductor integrated circuit device. Thus, generally used is a method of representing an actual analog circuit with a simple or equivalent circuit and modeling it.

### Macro Model (Comparative Example)

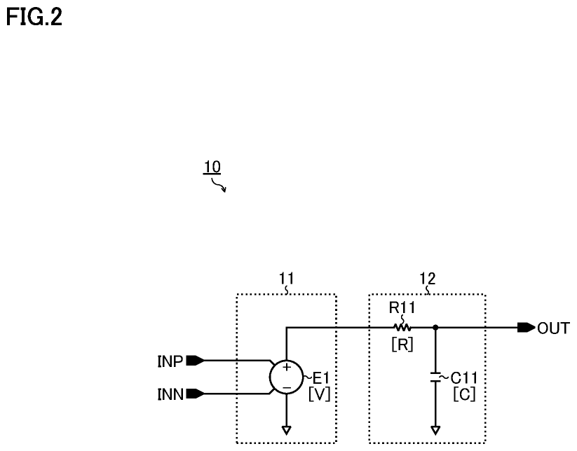

FIG. 2 is a diagram showing a comparative example (that is, a common configuration example to be compared with an embodiment, described later) of a macro model that simulates the operational amplifier 100. The macro model 10 of this comparative example includes a power supply block 11 and a filter block 12 as a plurality of functional blocks configured to approximately or equivalently represent the characteristics of the operational amplifier 100 on the circuit design simulator.

The power supply block 11 includes a direct-current power source E1 that receives the input of the first and second input signals INP and INN. An output voltage value V of the direct-current power source E1 is variable according to the difference between the first and second input signals INP and INN and corresponds to an internal parameter for representing the DC gain of the operational amplifier 100.

The filter block 12 is a one-stage RC filter that smooths the output voltage of the direct-current power source E1 to generate the output signal OUT and includes a resistor R11 and a capacitor C11. The resistance value R of the resistor R11 and the capacitance value C of the capacitor C11 each correspond to an internal parameter for representing the band width of the operational amplifier 100.

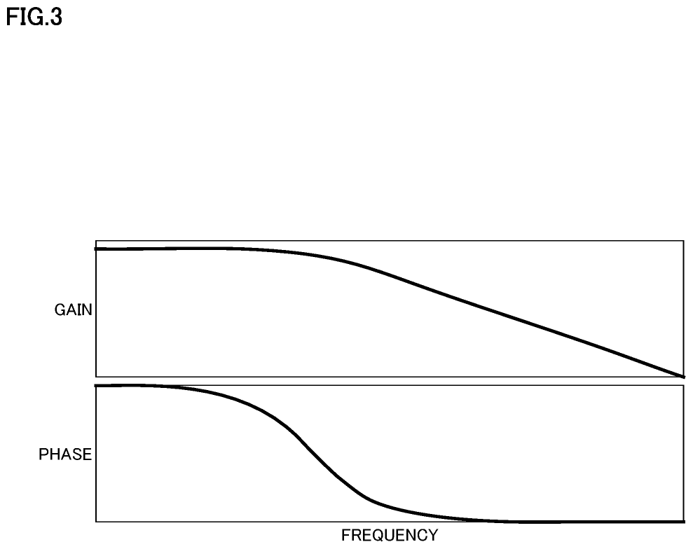

FIG. 3 is a Bode plot (top: gain plot, bottom: phase plot) showing the characteristics of the operational amplifier 100. In the gain and phase plots, the horizontal axes represents frequency. On the other hand, in the gain and phase plots, the vertical axes represents gain and phase, respectively, versus frequency.

When the macro model 10 of the operational amplifier 100 is created, various internal parameters (the output voltage value V, the resistance value R, and the capacitance value C) are adjusted so as to produce characteristics as shown in FIG. 3.

By using such a macro model 10, it is possible to reduce the computing load on the circuit design simulator, and to obtain simulation results in a shorter time.

However, depending on the semiconductor integrated circuit device to be modeled, there are often cases where no simple or equivalent circuit is found that can properly represent its characteristics. In that case, the characteristics of the semiconductor integrated circuit device cannot to be reflected in the macro model properly, and this lowers the accuracy of the simulation.

In the macro model 10 of the comparative example, some of the operation conditions (the supply voltage, the ambient temperature, etc.) are fixed to the typical values given on the data sheet of the operational amplifier 100. That is, no aspect of the operation condition dependence (supply voltage dependence, ambient temperature dependence, etc.) of the operational amplifier 100 is reflected in the macro model 10.

Thus, if, in the operation conditions of the macro model 10, for example, the ambient temperature is fixed to room temperature (25° C.), it is not possible to accurately simulate the characteristics of the operational amplifier 100 at high temperature (for example, 75° C.) or at low temperature (for example, −10° C.).

For example, with the macro model 10 of the comparative example, it is not possible to verify with a simulation the operation of a system such as a PCB incorporating the operational amplifier 100 while changing its operation conditions. Thus, whether a change in the operation conditions of the macro model 10 impairs the operation of the system or not has to be judged by inference from the data sheet, and a system that has passed verification in a simulation may fail to pass verification at the stage of test production.

As for a method of reflecting the operation condition dependence of the operational amplifier 100 (such as supply voltage dependence and ambient temperature dependence) in the macro model 10, for example, various internal parameters (the output voltage value V, the resistance value R, and the capacitance value C) of the macro model 10 can be set as functions of the supply voltage, the ambient temperature, and the like. However, to accurately represent the behavior of the operational amplifier 100 using such a method, it is necessary to derive appropriate functions in advance, and this requires a great deal of knowhow and many hours of studies.

Hereinafter, in view of the discussion above, some embodiments of the macro model 10 that can accurately simulate the behavior of a semiconductor integrated circuit device in actual environments will be presented.

### A Macro Model (First Embodiment)

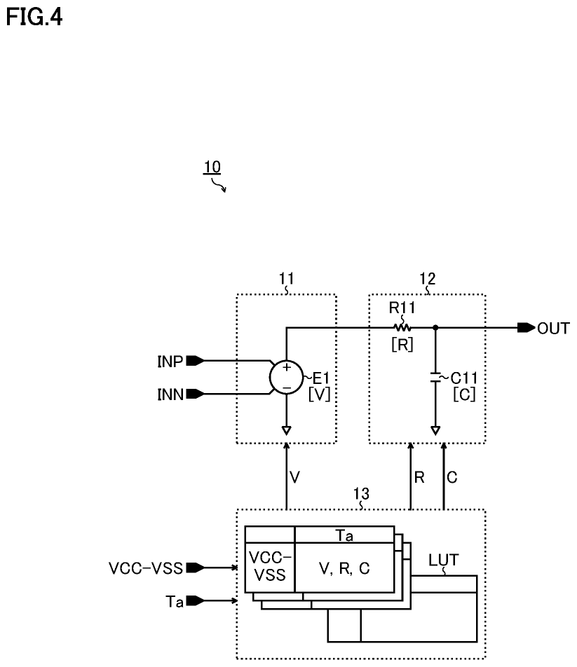

FIG. 4 is a diagram showing a macro model according to a first embodiment that simulates the operational amplifier 100. The macro model 10 of this embodiment is based on the comparative example (FIG. 2) discussed previously and further includes a characteristics setting block 13.

The characteristics setting block 13 receives at least one operation condition parameter related to the operation conditions of the operational amplifier 100. Examples of operation condition parameters include, for example, the supply voltage VCC, the reference voltage VSS, an ambient temperature Ta, an internal temperature Tj (a junction temperature), and a load current Iload with respect to the operational amplifier 100. In this embodiment, so that an operational amplifier 100 of a dual-supply type can be coped with, two arguments are set as operation condition parameters, namely a power supply range VCC-VSS (the difference between the supply voltage VCC and the reference voltage VSS) and the ambient temperature Ta. The reference voltage VSS can correspond to a ground voltage GND.

The characteristics setting block 13 sets at least one internal parameter out of a plurality of internal parameters set in each of the power supply block 11 and the filter block 12 using array data previously stored such that the characteristics of the operational amplifier 100 on the circuit design simulator reflect the operation condition parameters mentioned above. Examples of the plurality of internal parameters include, for example, the output voltage value V with respect to the power supply block 11 and the resistance value R and the capacitance value C with respect to the filter block 12. Of these internal parameters, any one or two can be set as variable values (that is, as the targets of setting by the characteristics setting block 13), or all three of them can be set as variable values.

Here, it is important that the array data previously stored in the characteristics setting block 13 be derived from evaluation measurement data obtained by actual measurement using the actual operational amplifier 100. The evaluation measurement data can be obtained, for example, by creating a plurality of Bode plots (see FIG. 3) while varying the operation conditions of the operational amplifier 100 and finding from the plots the DC gain, the band width, and the like of the operational amplifier 100 that vary with the varying operation conditions. Then, based on the evaluation measurement data, the set values of the internal parameters (the output voltage value V, the resistance value R, and the capacitance value C) to be set in each of the power supply block 11 and the filter block 12 can be derived, and those set values can be stored as the array data.

For the array data described above, it is preferable to use a one- or multi-dimensional lookup table LUT in which at least one operation condition parameter is associated with at least one internal parameter. In this embodiment, two-dimensional lookup table LUT is used in which two operation condition parameters (the power supply range VCC-VSS and the ambient temperature Ta) are associated with three internal parameters (the output voltage value V, the resistance value R, and the capacitance value C).

The macro model 10 of this embodiment can represent the characteristics of the operational amplifier 100 with the combination of the power supply block 11 and the filter block 12 while, using the lookup table LUT, optimizing the internal parameters of each of the power supply block 11 and the filter block 12 for varying operation conditions (that is, reproducing the behavior of an actual device).

For example, with the macro model 10 of this embodiment, it is possible, for a system such as a PCB incorporating the operational amplifier 100, to verify its operation so as to cover all the operation conditions by performing simulations while changing the operation conditions. Thus, it is possible to eliminate a possibility that a system that has passed verification in a simulation fails to pass verification at the stage of test production, and thus to enable smooth and speedy system designing.

The macro model 10 of this embodiment reflects the operation condition dependence (such as supply voltage dependence and ambient temperature dependence) of the operational amplifier 100 not by converting the internal parameters of the macro model 10 into functions but by setting the internal parameters of the macro model 10 using array data (that is, the lookup table LUT) derived from the evaluation measurement data obtained by actual measurement. With this configuration, it is possible to reproduce the behavior of an actual device under various operation conditions with high accuracy without the need of deriving appropriate functions.

The macro model 10 of this embodiment can be applied generally to a series of models that, while having the same functions as the operational amplifier 100, differ in some characteristics (such as a high-gain type, a low-gain type, a high-frequency compatible type, and a high-current compatible type). For example, by preparing a single macro model 10 as the basis of all the series models and rewriting the lookup table LUT based on the evaluation measurement data obtained by actual measurement with individual models, it is possible to adapt the single macro model 10 to all the series models.

By setting the lookup table LUT so as to bypass at least one of a plurality of functional blocks, it is possible to reproduce also the characteristics of a model with similar function as the operational amplifier 100.

### A Macro Model (Second Embodiment)

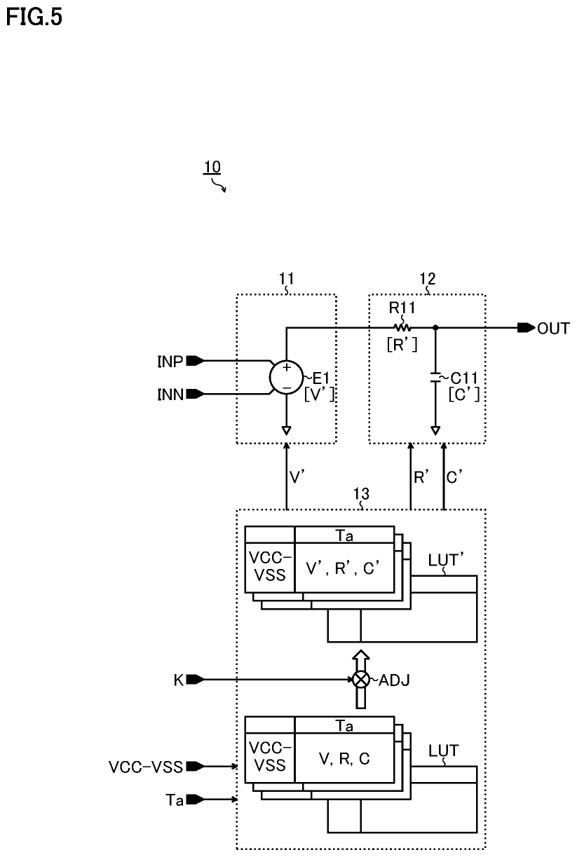

FIG. 5 is a diagram showing a macro model according to a second embodiment that simulates the operational amplifier 100. The macro model 10 of this embodiment is based on the first embodiment (FIG. 4) discussed previously and further includes a parameter adjuster ADJ as a circuit element of the characteristics setting block 13.

The characteristics setting block 13 receives a characteristics variation parameter K related to the characteristics variation of the operational amplifier 100. Based on the internal parameters (the output voltage value V, the resistance value R, and the capacitance value C) stored in the lookup table LUT and the characteristics variation parameter K, the parameter adjuster ADJ generates a lookup table LUT′ (an output voltage value V′, a resistance value R′, and a capacitance value C′) reflecting the characteristics variation of the operational amplifier 100. The lookup table LUT′ here corresponds to characteristics variation array data reflecting the characteristics variation of the operational amplifier 100.

For example, as shown in the diagram, the characteristics variation parameter K may be a coefficient by which to multiply the internal parameters. In this case, V′=V×K, R′=R×K, and C′=C×K. The characteristics variation parameter K may be an offset to be added to or subtracted from the internal parameters. In this case, V′=V±K, R′==R±K, and C′=C±K. A plurality of characteristics variation parameters K may be prepared one for each internal parameter.

The internal parameters (the output voltage value V′, the resistance value R′, and the capacitance value C′) for each of the power supply block 11 and the filter block 12 are set using the lookup table LUT′ mentioned above.

With the macro model 10 of this embodiment, it is possible to perform a simulation taking the characteristics variation of the operational amplifier 100 into account, and thus to obtain more accurate simulation results.

<Interpolation Computation>

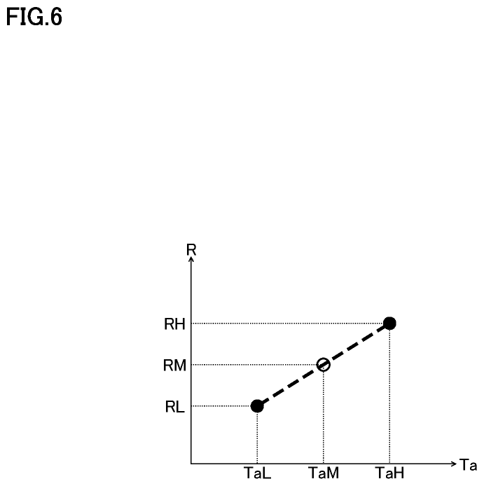

FIG. 6 is a diagram showing interpolation operation for an internal parameter by the characteristics setting block 13. The horizontal axis in the diagram represents the ambient temperature Ta as one example of an operation condition parameter, and the vertical axis in the diagram represents the resistance value R as one example of an internal parameter.

As shown in FIG. 6, the characteristics setting block 13 has a function of interpolating, for at least one internal parameter (for example, the resistance value R), the intermediate value (hollow circle) of two set values (sold circles) derived from the lookup table LUT.

For example, suppose that the resistance value R to be set when Ta=TaL (for example, 25° C.) is RL and that the resistance value R to be set when Ta=TaH (for example, 75° C.) is RH. The relationship between the ambient temperature TaL and the resistance value RL and the relationship between the ambient temperature TaH and the resistance value RH are stored as a lookup table LUT in the characteristics setting block 13. Thus, when Ta=TaL, R=RL can be read from the lookup table LUT; when Ta=TaH, R=RH can be read from the lookup table LUT.

On the other hand, for the resistance value R (=RM) to be set when Ta=TaM (for example, 50° C.), no evaluation measurement data by actual measurement with the operational amplifier 100 may have been obtained in advance. In that case, R=RM cannot be read directly from the lookup table LUT.

However, in the characteristics setting block 13, from the resistance values RL (@TaL) and RH (@TaH) derived from the lookup table LUT, the resistance value RM (@TaM) corresponding to the intermediate value of those two resistance values can be calculated.

Thus, it is possible to minimize the task of obtaining evaluation measurement data in advance by actual measurement with the operational amplifier 100 and to compress the data size of the lookup table LUT in the characteristics setting block 13.

By dynamically performing the interpolation operation described above, it is possible to model the dynamic change in the characteristics of the operational amplifier 100 with high accuracy and ease.

Although the above embodiments deal with examples of macro models 10 simulating an operational amplifier 100, the configurations of the operational amplifier 100 and the macro model 10 there are merely examples. Needless to say, the above embodiments can be applied also to a macro model simulating any semiconductor integrated circuit device other than an operational amplifier.

<Circuit Design Simulator>

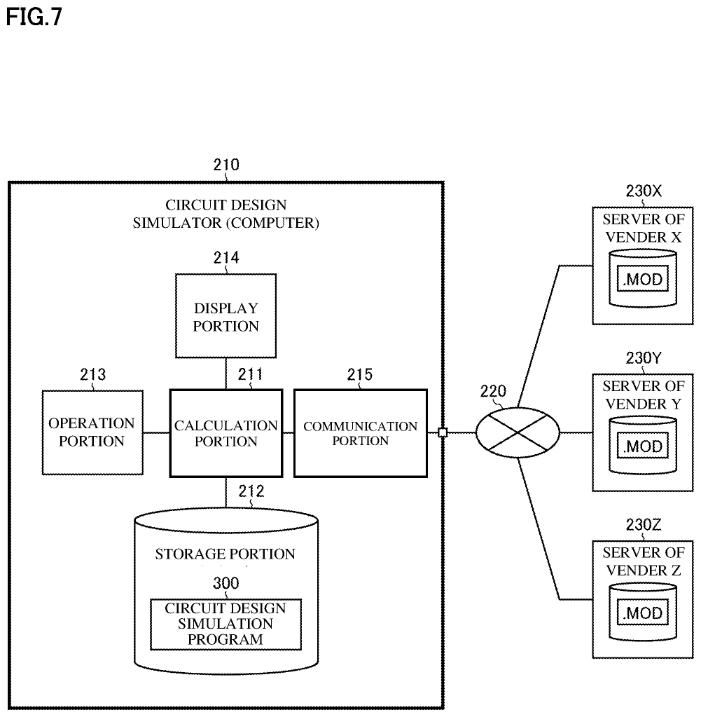

FIG. 7 is a block diagram showing one configuration example of a circuit design simulator that employs the macro model 10 described previously. The circuit design simulator 210 of this configuration example is a computer including a calculation portion 211, a storage portion 212, an operation portion 213, a display portion 214, and a communication portion 215, and is implemented by the calculation portion 211 executing a circuit design simulation program 300 stored in the storage portion 212.

The calculation portion 211 comprehensively controls the operation of the circuit design simulator 210. For example, the calculation portion 211 executes the circuit design simulation program 300 stored in the storage portion 212 and performs various arithmetic operations to make the computer function as the circuit design simulator 210. The calculation portion 211 also recognizes user operations on the operation portion 213, controls display of different screens on the display portion 214, etc. For the calculation portion 211, for example, a CPU (central processing unit) can be used.

The storage portion 212 is used as a storage area for an OS (operation system) program and various software programs (including the circuit design simulation program 300) and also as a storage area for different kinds of data created by a user and as a working area for various software programs. For the storage portion 212, a hard disc drive, a solid state drive, a USB (universal serial bus) memory, and the like can be used.

The operation portion 213 accepts various user operations (a circuit creation operation, a component reference operation, a probe installation operation, etc.) and transmits them to the calculation portion 211. For the operation portion 213, a keyboard, a mouse, a trackball, a pen tablet, a touch panel, and the like can be used.

The display portion 214 displays various screens (a circuit creation field, a component pallet, a waveform drawing window, etc.) based on instructions from the calculation portion 211. For the display portion 214, a liquid crystal display and the like can be used.

The communication portion 215 communicates information via a telecommunication line 220 (the Internet, a LAN (local area network), etc.) based on instructions from the calculation portion 211. For example, the communication portion 15 communicates information via the telecommunication line 220 with servers 230X to 230Z at vendors manufacturing and distributing semiconductor integrated circuit devices, to download macro model files (*.mod) and the like.

By using such a circuit design simulator 210, it is possible to perform simulation verification (characteristics evaluation, operation checking, etc.) with an analog circuit before it is actually test-produced.

<Circuit Design Simulation Program>

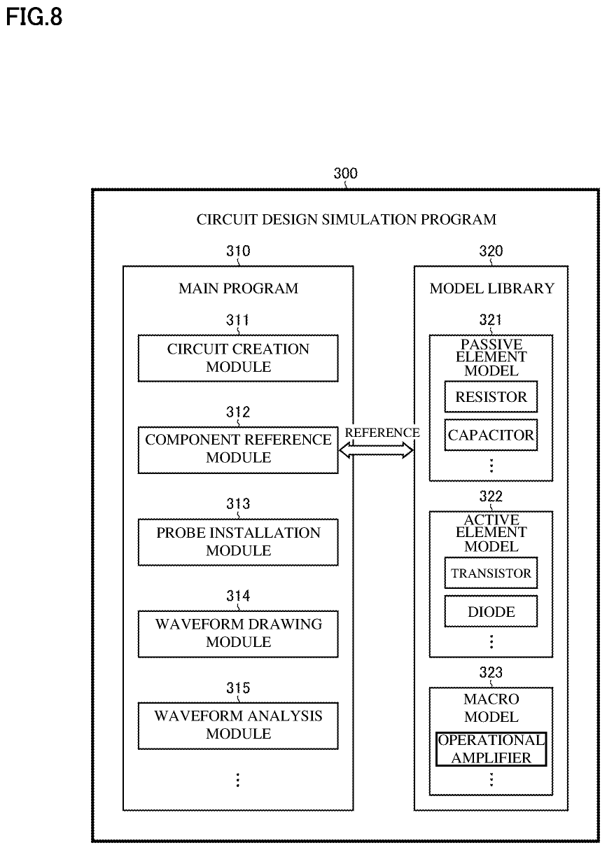

FIG. 8 is a diagram showing one configuration example of the circuit design simulation program 300. The circuit design simulation program 300 (for example, a SPICE circuit design simulation program) is a software program that is executed by a computer to make the computer function as the circuit design simulator 210 (see FIG. 7). The circuit design simulation program 300 of this configuration example includes a main program 310 and a model library 320. The circuit design simulation program 300 is transferred or distributed via a physical media such as an optical disc (a CD-ROM, a DVD-ROM, etc.) or a semiconductor memory (a USB memory, etc.) or via a telecommunication line such as the Internet.

The main program 310 is the base for making the computer function as the circuit design simulator 210 and is formed as a combination of different module programs (for example, a circuit creation module 311, a component reference module 312, a probe installation module 313, a waveform drawing module 314, and a waveform analysis module 315).

The circuit creation module 311 is an element program for making the calculation portion 211 and the display portion 214 create a circuit on the circuit design simulator 210 based on input on the operation portion 213. Using the operation portion 213, a user can arrange, in the circuit creation field, component symbols (resistor, capacitor, transistor, diode, operational amplifier, voltage source, current source, wiring, etc.) displayed on the display portion 214; this leads the circuit creation module 311 to create text-based code in accordance with the arrangement. In this way, a user can create any analog circuit intuitively without directly editing text-based code.

The component reference module 312 is an element program for making the calculation portion 211 and the display portion 214 refer to the model library 320 based on input on the operation portion 213. For example, using the operation portion 213, a user can select the symbol for the operational amplifier from the component pallet displayed on the display portion 214; this leads the component reference module 312 to refer to a macro model 323 of the operational amplifier (corresponding to the macro model 10 described previously) in the model library 320.

The probe installation module 313 is an element program for making the calculation portion 211 and the display portion 214 install a probe (point for measurement of a voltage or current) on the circuit diagram based on input on the operation portion 213. For example, using the operation portion 213, a user can click with a mouse a specific node on the circuit diagram displayed on the display portion 214; this leads the probe installation module 313 to install a probe at the clicked node.

The waveform drawing module 314 is an element program for making the calculation portion 211 and the display portion 214 draw, based on input on the operation portion 213, the waveform at the node at which the probe is installed. For example, when a user using the operation portion 213 installs a probe at the output terminal of the operational amplifier displayed on the display portion 214, the waveform drawing module 314 displays the output waveform (simulated oscilloscope waveform) of the operational amplifier in the waveform drawing window.

The waveform analysis module 315 is an element program for making the calculation portion 211 and the display portion 214 analyze, based on input on the operation portion 213, the waveform at the node at which the probe is installed. Examples of waveform analysis that can be performed in the waveform analysis module 315 include transition analysis, direct-current analysis, small-signal alternating-current analysis, noise analysis, and the like.

The model library 320 includes various simulation models (a passive element model 321, an active element model 322, the macro model 323, etc.) used on the circuit design simulator 210 and is referred to, as a component of the circuit design simulation program 300, by the main program 310 (in particular, by the component reference module 312). The passive element model 321 is a program for making the computer simulate the response of a passive element (resistor, capacitor, etc.) on the circuit design simulator 210. The active element model 322 is a program for making the computer simulate the response of an active element (transistor, diode, etc.) on the circuit design simulator 210. The macro model 323 of the operational amplifier (corresponding to the macro model described previously) is a program for making the computer simulate the response of the operational amplifier on the circuit design simulator 210. Some of the simulation models (the passive element model 321, the active element model 322, and the macro model 323) described above can be downloaded for free via the telecommunication line 220 from the servers 230X to 230Z at vendors manufacturing and distributing semiconductor integrated circuit devices.

By using such a circuit design simulation program 300, it is possible to use a general-purpose computer (personal computer, work station, etc.) as the circuit design simulator 210.

<Overview>

To follow is an overview of the various embodiments described thus far.

For example, according to one aspect of what is disclosed herein, a macro model of a semiconductor integrated circuit device is for use on a circuit design simulator and includes: a plurality of functional blocks configured to approximately or equivalently represent the characteristics of the semiconductor integrated circuit device on the circuit design simulator; and a characteristics setting block configured to set, using array data derived from evaluation measurement data obtained by actual measurement with the semiconductor integrated circuit device, at least one internal parameter out of a plurality of internal parameters set in the plurality of functional blocks. (A first configuration.)

In the macro model according to the first configuration described above, preferably, the characteristics setting block is configured to receive at least one operation condition parameter related to the operation conditions of the semiconductor integrated circuit device. Preferably, the characteristics setting block is also configured to set the at least one internal parameter such that the characteristics of the semiconductor integrated circuit device on the circuit design simulator reflect the at least one operation condition parameter. (A second configuration.)

In the macro model according to the second configuration described above, preferably, the array data is a one- or multi-dimensional lookup table in which the at least one operation condition parameter is associated with the at least one internal parameter. (A third configuration.)

In the macro model according to the second or third configuration described above, preferably, the at least one operation condition parameter includes at least one of a supply voltage, a reference voltage, an ambient temperature, an internal temperature, and a load current with respect to the semiconductor integrated circuit device. (A fourth configuration.)

In the macro model according to any of the first to fourth configurations described above, preferably, the characteristics setting block is configured to receive a characteristics variation parameter related to the characteristics variation of the semiconductor integrated circuit device. Preferably, the characteristics setting block is also configured to generate characteristics variation array data reflecting the characteristics variation based on the array data and the characteristics variation parameter. Preferably, the characteristics setting block is also configured to set the at least one internal parameter using the characteristics variation array data. (A fifth configuration.)

In the macro model according to any of the first to fifth configurations described above, preferably, the characteristics setting block is configured to interpolate, for the at least one internal parameter, an intermediate value of two set values derived from the array data. (A sixth configuration.)

In the macro model according to any of the first to sixth configurations described above, preferably, the semiconductor integrated circuit device is an operational amplifier. (A seventh configuration.)

In the macro model according to the seventh configuration described above, preferably, the plurality of functional blocks include a power supply block that represents the DC gain of the operational amplifier and a filter block that represents the band width of the operational amplifier. (An eighth configuration.)

In the macro model according to the eighth configuration described above, preferably, the plurality of internal parameters are an output voltage value with respect to the power supply block and a resistance value and a capacitance value with respect to the filter block. (A ninth configuration.)

According to another aspect of what is disclosed herein, a circuit design simulation program is executed by a computer including a calculation portion to make the computer function as a circuit design simulator. The program includes the macro model according to any of the first to ninth configurations described above and makes the computer simulate the response of a semiconductor integrated circuit device on the circuit design simulator. (A tenth configuration.)

According to yet another aspect of what is disclosed herein, a circuit design simulator is implemented by a computer executing the circuit design simulation program according to the tenth configuration described above. (An eleventh configuration.)

According to the present disclosure, it is possible to provide a highly accurate and versatile macro model of a semiconductor integrated circuit device, and to provide a circuit design simulation program and a circuit design simulator that employ such a macro model.

### FURTHER MODIFICATIONS

The various technical features disclosed herein may be implemented in any other manners than in the embodiments described above, and allow for any modifications made without departure from their technical ingenuity. That is, the above embodiments should be understood to be in every aspect illustrative and not restrictive. The scope of the present disclosure is defined not by the description of the embodiments given above but by the appended claims, and should be understood to encompass any modifications made in a sense and scope equivalent to those of the claims.

1. A macro model of a semiconductor integrated circuit device for use on a circuit design simulator, comprising:
a plurality of functional blocks configured to approximately or equivalently represent characteristics of the semiconductor integrated circuit device on the circuit design simulator; and
a characteristics setting block configured to set, using array data derived from evaluation measurement data obtained by actual measurement with the semiconductor integrated circuit device, at least one internal parameter out of a plurality of internal parameters set in the plurality of functional blocks.

2. The macro model according to claim 1,
wherein
the characteristics setting block is configured
to receive at least one operation condition parameter related to operation conditions of the semiconductor integrated circuit device, and
to set the at least one internal parameter such that the characteristics of the semiconductor integrated circuit device on the circuit design simulator reflect the at least one operation condition parameter.

3. A macro model according to claim 2, wherein
the array data is a one- or multi-dimensional lookup table in which the at least one operation condition parameter is associated with the at least one internal parameter.

4. The macro model according to claim 2,
wherein
the at least one operation condition parameter includes at least one of a supply voltage, a reference voltage, an ambient temperature, an internal temperature, and a load current with respect to the semiconductor integrated circuit device.

5. The macro model according to claim 1,
wherein
the characteristics setting block is configured
to receive a characteristics variation parameter related to characteristics variation of the semiconductor integrated circuit device,
to generate characteristics variation array data reflecting the characteristics variation based on the array data and the characteristics variation parameter, and
to set the at least one internal parameter using the characteristics variation array data.

6. The macro model according to claim 1,
wherein
the characteristics setting block is configured to interpolate, for the at least one internal parameter, an intermediate value of two set values derived from the array data.

7. The macro model according to claim 1,
wherein
the semiconductor integrated circuit device is an operational amplifier.

8. The macro model according to claim 7,
wherein
the plurality of functional blocks include
a power supply block that represents a DC gain of the operational amplifier, and
a filter block that represents a band width of the operational amplifier.

9. The macro model according to claim 8,
wherein
the plurality of internal parameters are an output voltage value with respect to the power supply block and a resistance value and a capacitance value with respect to the filter block.

10. A circuit design simulation program to be executed by a computer including a calculation portion to make the computer function as a circuit design simulator,
the program including the macro model according to claim 1,
the program making the computer simulate a response of a semiconductor integrated circuit device on the circuit design simulator.

11. A circuit design simulator that is implemented by a computer executing the circuit design simulation program according to claim 10.
